(19) United States
(12) Patent Application Publication
(10) Pub. No.: US 2021/0008716 A1
(43) Pub. Date: Jan. 14, 2021

(54) PATROL METHOD USING ROBOT AND APPARATUS AND ROBOT THEREOF

(71) Applicant: U8TECM ROBOTICS CGRP LTD, Shenzhen (CN)

(72) Inventors: Gaobo Huang, Shenzhen (CN); Jiawen Hu, Shenzhen (CN); Youjun Xiong, Shenzhen (CN)

(21) Appl. No.: 16/538,856

(22) Filed: Aug. 13, 2019

(30) Foreign Application Priority Data
Jul. 11, 2019 (CN) 201910622871.X

(51) Int. Cl. B25J 9/16; G05D 1/02

(52) U.S. Cl. CPC B25J 9/163; G05D 1/0274; B25J 9/1676; G05D 1/027

(57) ABSTRACT

The present disclosure provides a patrol method using a robot as well as an apparatus and a robot thereof. The method includes: obtaining a preset patrol configuration file and reading a patrol sequence, a coordinate, and a navigation method of each patrol point from the patrol configuration file, wherein the patrol configuration file comprises at least two navigation methods; obtaining a preset electronic map and obtaining a starting coordinate of the robot in the electronic map through a localization equipment; and controlling the robot to move from the starting coordinate to the coordinate of each patrol point according to the patrol sequence by navigating the robot using the navigation method corresponding to the n-th patrol point in the patrol configuration file during moving the robot to the coordinate of the n-th patrol point. In comparison with the prior art, which improves the patrol efficiency of the robot.

### CROSS REFERENCE TO RELATED APPLICATIONS

This application claims priority to Chinese Patent Application No. 20191062287.X, filed Jul. 11, 2019, which is hereby incorporated by reference herein as if set forth in its entirety.

### BACKGROUND

### 1. Technical Field

The present disclosure relates to robot technology, and particularly to a patrol method using a robot as well as an apparatus and a robot thereof.

### 2. Description of Related Art

In the prior art, a robot can be used to patrol the places such as a power control system room and a railway integrated control system room. The current patrol method using a robot generally adopts a single free navigation method. However, because the free navigation method involves continuous global planning and continuous local planning, it will take much time in each planning, and the larger the map, the longer the time will take, for example, for a map of one thousand square meters, the time for global planning may take 4-5 seconds or more, and the patrol efficiency of the robot is low.

### BRIEF DESCRIPTION OF THE DRAWINGS

To describe the technical schemes in the embodiments of the present disclosure more clearly, the following briefly introduces the drawings required for describing the embodiments or the prior art. Apparently, the drawings in the following description merely show some examples of the present disclosure. For those skilled in the art, other drawings can be obtained according to the drawings without creative efforts.

FIG. 1 is a flow chart of a patrol method using a robot according to an embodiment of the present disclosure.

FIG. 2 is a schematic diagram of an example of a usage scenario of the method of FIG. 1.

FIG. 3 is a flow chart of an example of patrolling using a local navigation method in the method of FIG. 1.

FIG. 4 is a schematic diagram of an example of patrolling using a local navigation method in the method of FIG. 1.

FIG. 5 is a schematic diagram of an example of a patrol process of a robot in the method of FIG. 1.

FIG. 6 is a schematic block diagram of a patrol apparatus according to an embodiment of the present disclosure.

FIG. 7 is a schematic block diagram of a robot according to an embodiment of the present disclosure.

### DETAILED DESCRIPTION

In order to make the object, the features and the advantages of the present disclosure more obvious and easy to understand, the technical solutions in the embodiments of the present disclosure will be clearly and completely described below in conjunction with the accompanying drawings in the embodiments of the present disclosure. It should be noted that, the described embodiments are only a part of the embodiments of the present disclosure, instead of all of the embodiments. All other embodiments obtained by those who skilled in the art based on the embodiments of the present disclosure without creative efforts are within the scope of the present disclosure.

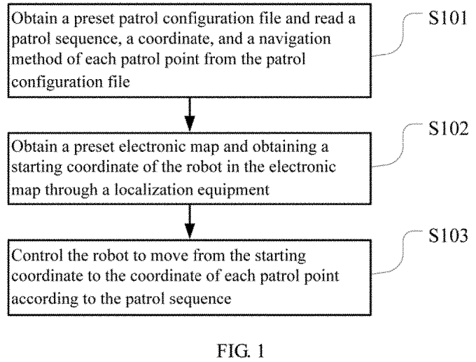

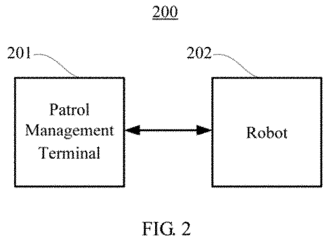

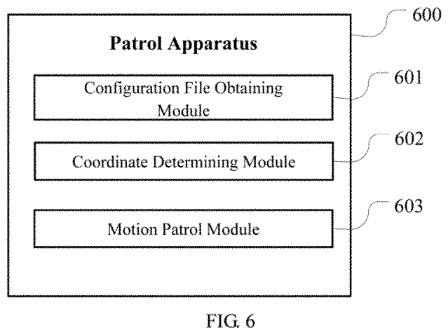

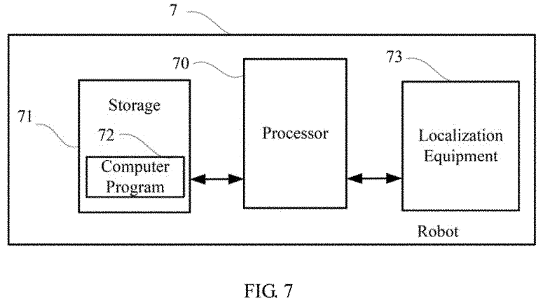

FIG. is a flow chart of a patrol method using a robot according to an embodiment of the present disclosure. In this embodiment, a patrol method using a robot for a robot having a localization equipment is provided. The method is a computer-implemented method executable for a processor, which may be implemented through and applied to a patrol system shown in FIG. 2, a patrol apparatus shown in FIG. 6, or a robot shown in FIG. 7, or implemented through a computer readable storage medium. As shown in FIG. 1, the method includes the following steps.

S101: obtaining a preset patrol configuration file and reading a patrol sequence, a coordinate, and a navigation method of each patrol point from the patrol configuration file.

In which, the patrol configuration file includes at least two navigation methods, which include but are not limited to a free navigation method and a local navigation method.

FIG. 2 is a schematic diagram of an example of a usage scenario of the method of FIG. 1. As shown in FIG. 2, in this usage scenario, a patrol system 200 includes a patrol management terminal 201 and a robot 202 for performing patrols. The patrol management terminal 201 may be a computing device such as a mobile phone, a tablet, a desktop computer, a laptop computer, a pocket PC (personal computer), or a cloud server. The patrol configuration file is stored in the patrol management terminal 201, and its content may be set according to actual needs.

In this embodiment, the robot 202 is the main body to implement the patrol method. When the patrol is to be performed, the patrol management terminal 201 can issue a patrol instruction to the robot 202, and the robot 202 can perform the patrol process after receiving the patrol instruction.

The robot 202 can obtain the patrol configuration file from the patrol management terminal 201, and read the patrol sequence, the coordinate, and the navigation method of each patrol point from the patrol configuration file. The number of the patrol points may be set according to actual needs. In this embodiment, the total number of patrol points in the patrol configuration file is marked as N.

S102: obtaining a preset electronic map and obtaining a starting coordinate of the robot in the electronic map through the localization equipment.

The electronic map may be stored in a storage medium (e.g., a hard disk or a flash card) of the robot in advance, or may be obtained by the robot from the patrol management terminal 201. After importing the electronic map, the robot can determine its starting coordinate in the electronic map by a localization method through the localization equipment such as a laser sensor or a UWB (ultra-wideband) tag. The localization method may be any one of the localization methods commonly used in the prior art such as AMCL (adaptive Monte Carlo localization) or UWB localization, which is not limited herein.

S103: controlling the robot to move from the starting coordinate to the coordinate of each patrol point according to the patrol sequence.

In which, in the process of moving the robot to the coordinate of the n-th patrol point, the navigation method corresponding to the n-th patrol point in the patrol configuration file is used for navigation, where 1≤n≤N.

In the case that the navigation method corresponding to the n-th patrol point in the patrol configuration file is the free navigation method, a global path planning can be first performed to obtain an optimal global path from the coordinate of the n−1-th patrol point to the coordinate of the n-th patrol point, where the starting coordinate can be taken as a special patrol point, that is, the 0-th patrol point. After obtaining the optimal global path, the robot can be controlled to move according to the optimal global path, and perform an obstacle avoidance processing and a partial path planning during the movement to avoid obstacles on the optimal global path.

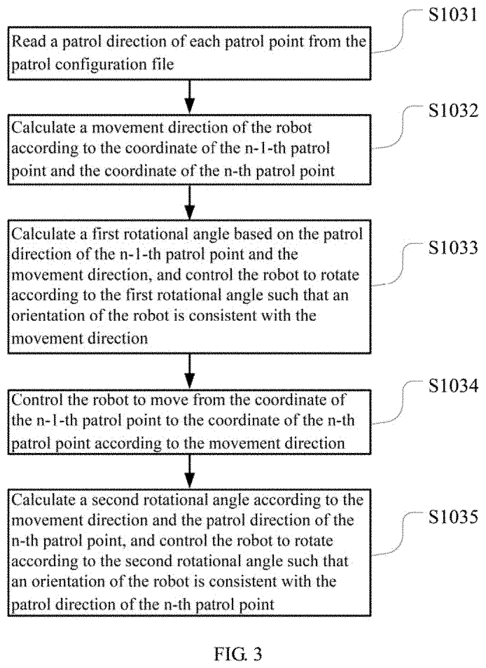

FIG. 3 is a flow chart of an example of patrolling using a local navigation method in the method of FIG. 1. In the case that the navigation method corresponding to the n-th patrol point in the patrol configuration file is the local navigation method, the navigation can be performed by the method shown in FIG. 3. As shown in FIG. 3, the method includes the following steps.

S1031: reading a patrol direction of each patrol point from the patrol configuration file.

The patrol direction is a direction in which a front side of the robot orients when the robot is at the patrol point. For example, if the robot has to check whether the working state of a certain instrument is normal at a certain patrol point, the patrol direction of the patrol point should be set to a direction facing the instrument.

In this embodiment, for the sake of simplicity, the direction can be expressed as a two-dimensional vector. For example, the patrol direction of the n-th patrol point can be expressed as: (dirXₙ, dirYₙ).

S1032: calculating a movement direction of the robot according to the coordinate of the n−1-th patrol point and the coordinate of the n-th patrol point.

Herein, the coordinate of the n−1-th patrol point is marked as (xₙ₋₁, yₙ₋₁), and the coordinate of the n-th patrol point is marked as (xₙ, yₙ), then the movement direction of the robot can be expressed as (xₙ−xₙ₋₁, yₙ−yₙ₋₁).

S1033: calculating a first rotational angle based on the patrol direction of the n−1-th patrol point and the movement direction, and controlling the robot to rotate according to the first rotational angle such that an orientation of the robot is consistent with the movement direction.

In which, the first rotational angle can be calculated based on the following formula:

$$cos Φ 1 = \frac{( {x}_{n} - {x}_{n - 1} ) \times {dirX}_{n - 1} + ( {y}_{n} - {y}_{n - 1} ) \times dir {Y}_{n - 1}}{\sqrt{{( {x}_{n} - {x}_{n - 1} )}^{2} + {( {y}_{n} - {y}_{n - 1} )}^{2}} \times \sqrt{dir {X}_{n - 1}^{2} + dir {Y}_{n - 1}^{2}}} ;$$

where, φ1 is the first rotational angle. After the first rotational angle is obtained, the robot can be controlled to rotate according to the first rotational angle such that the orientation of the robot is consistent with (e.g., the same as) the movement direction.

S1034: controlling the robot to move from the coordinate of the n−1-th patrol point to the coordinate of the n-th patrol point according to the movement direction.

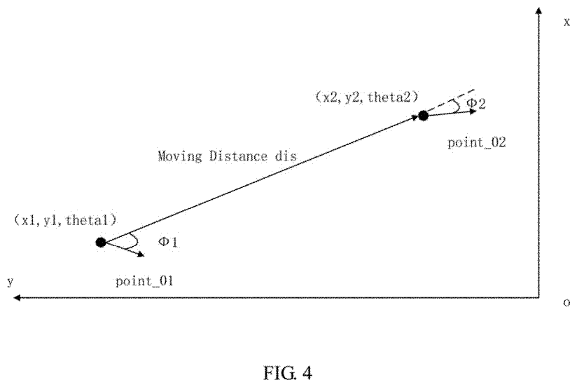

FIG. 4 is a schematic diagram of an example of patrolling using a local navigation method in the method of FIG. 1. As shown in FIG. 4, the moving distance dis of the robot can be calculated based on the following formula:

dis=\sqrt{(xₙ−xₙ₋₁)²+(yₙ−yₙ₋₁)²};

where, dis is the moving distance of the robot.

S1035: calculating a second rotational angle according to the movement direction and the patrol direction of the n-th patrol point, and controlling the robot to rotate according to the second rotational angle such that the orientation of the robot is consistent with the patrol direction of the n-th patrol point.

In which, the second angle can be calculated based on the following formula:

$$cos Φ 2 = \frac{( {x}_{n} - {x}_{n - 1} ) \times dir {X}_{n} + ( {y}_{n} - {y}_{n - 1} ) \times dir {Y}_{n}}{\sqrt{{( {x}_{n} - {x}_{n - 1} )}^{2} + {( {y}_{n} - {y}_{n - 1} )}^{2}} \times \sqrt{dir {X}_{n}^{2} + dir {Y}_{n}^{2}}} ;$$

where, φ2 is the second rotational angle. As shown in FIG. 4, after the first rotational angle is obtained, the robot can be controlled to rotate according to the second rotational angle such that the orientation of the robot is consistent with (e.g., the same as) the patrol direction of the n-th patrol point.

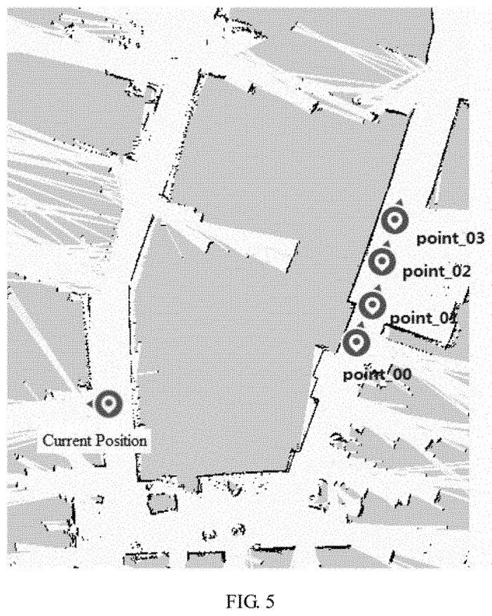

FIG. 5 is a schematic diagram of an example of a patrol process of a robot in the method of FIG. 1. As shown in FIG. 5, a working map of the robot is generated by scanning through a radar of the robot. In the patrol process of the robot, the robot on the map is moved from the current position to the patrol points including point_00, point_01, point_02, and point_03 successively based on the patrol configuration file to perform a patrol, where the distance between the above-mentioned points of point_00, point_01, point_02, and point_03 points is relatively short which usually less than 1 meter. In FIG. 5, the movement from the current position to point_00 is a long-distance movement, and the environment during the movement is relatively complicated, hence it is necessary to use global navigation and mobile planning, and the free navigation method based on path planning is used. Since the patrol points of point_00, point_01, point_02, point_03 are close, and the environment during the movement is relatively simple, the local navigation method is used so that the time for calculation and planning will not be too long.

Furthermore, after controlling the robot to move from the starting coordinate to the coordinate of each patrol point according to the patrol sequence, patrol operation information of each patrol point can be read from the patrol configuration file, and the robot can be controlled to perform a corresponding patrol operation at each patrol point. The patrol operation information may include, but is not limited to, need shoot recognition or not, the height of a lifting rod when shooting, angle and focal length of the camera, or the like. The robot performs corresponding patrol operations such as checking whether the working state of the instrument of each patrol point is normal or whether there is fire alarm information, based on the information.

In summary, in this embodiment, it no longer uses a single free navigation method, but uses at least two navigation methods in combination and configures the patrol configuration file according to the actual situation in advance. When the robot needs to perform patrols, the patrol configuration file can be first obtained, and the patrol sequence, the coordinate, and the navigation method of each patrol point are read therefrom. Then, it obtains the preset electronic map, obtains the starting coordinate of the robot in the electronic map through the localization equipment, controls the robot to move from the starting coordinate to the coordinate of each patrol point according to the patrol sequence by navigating the robot using the navigation method corresponding to the n-th patrol point in the patrol configuration file during moving the robot to the coordinate of the n-th patrol point, where 1≤n≤N, and N is an amount of the patrol point in the patrol configuration file. In this way, a plurality of navigation methods can be used in combination. In comparison with the prior art that uses a single free navigation method, which greatly saves time consumption and improves the patrol efficiency of the robot.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 6 is a schematic block diagram of a patrol apparatus according to an embodiment of the present disclosure, which corresponds to the patrol method of the above-mentioned embodiments. In this embodiment, a patrol apparatus 600 for a robot having a localization equipment is provided. The patrol apparatus 600 can be applied to the robot 202 of the patrol system shown in FIG. 2 or a robot shown in FIG. 7, or be the robot itself. As shown in FIG. 6, in this embodiment, a patrol apparatus 600 may include:

a configuration file obtaining module 601 configured to obtain a preset patrol configuration file and read a patrol sequence, a coordinate, and a navigation method of each patrol point from the patrol configuration file, where the patrol configuration file includes at least two navigation methods;

a coordinate determining module 602 configured to obtain a preset electronic map and obtain a starting coordinate of the robot in the electronic map through the localization equipment; and

a motion patrol module 603 configured to control the robot to move from the starting coordinate to the coordinate of each patrol point according to the patrol sequence by navigating the robot using the navigation method corresponding to the n-th patrol point in the patrol configuration file during moving the robot to the coordinate of the n-th patrol point, where 1≤n≤N, and N is an amount of the patrol point in the patrol configuration file.

Furthermore, the navigation methods may include a free navigation method and a local navigation method. In the case that the navigation method corresponding to the n-th patrol point in the patrol configuration file is the free navigation method, the motion patrol module 603 includes:

a global path planning unit configured to perform a global path planning to obtain an optimal global path from the coordinate of the n−1-th patrol point to the coordinate of the n-th patrol point; and

an obstacle avoidance unit configured to control the robot to move according to the optimal global path, and performing an obstacle avoidance processing and a partial path planning during the movement to avoid obstacles on the optimal global path.

Furthermore, in the case that the navigation method corresponding to the n-th patrol point in the patrol configuration file is the local navigation method, the motion patrol module 603 includes:

a patrol direction reading unit configured to read a patrol direction of each patrol point from the patrol configuration file;

a movement direction calculating unit configured to calculate a movement direction of the robot according to the coordinate of the n−1-th patrol point and the coordinate of the n-th patrol point;

a first rotation unit configured to calculating a first rotational angle based on the patrol direction of the n−1-th patrol point and the movement direction, and controlling the robot to rotate according to the first rotational angle such that an orientation of the robot coincides with the movement direction;

a movement control unit configured to control the robot to move from the coordinate of the n−1-th patrol point to the coordinate of the n-th patrol point according to the movement direction; and

a second rotation unit configured to calculate a second rotational angle according to the movement direction and the patrol direction of the n-th patrol point, and controlling the robot to rotate according to the second rotational angle such that an orientation of the robot coincides with the patrol direction of the n-th patrol point.

Furthermore, the patrol apparatus 600 may further include:

a patrol operation module configured to read patrol operation information of each patrol point from the patrol configuration file, and control the robot to perform a patrol operation corresponding to the patrol operation information at each patrol point.

In this embodiment, each of the above-mentioned modules/units is implemented in the form of software, which can be computer program(s) stored in a memory of the patrol apparatus 600 and executable on a processor of the patrol apparatus 600. In other embodiments, each of the above-mentioned modules/units may be implemented in the form of hardware (e.g., a circuit of the patrol apparatus 600 which is coupled to the processor of the patrol apparatus 600) or a combination of hardware and software (e.g., a circuit with a single chip microcomputer).

Those skilled in the art can clearly understand that, for the convenience and brevity of the description, the details of the working process of the above-mentioned apparatus, module, and unit can refer to the corresponding process in the above-mentioned method embodiment, which are not described herein.

In the above-mentioned embodiments, the description of each embodiment has its focuses, and the parts which are not described or mentioned in one embodiment may refer to the related descriptions in other embodiments.

FIG. 7 is a schematic block diagram of a robot according to an embodiment of the present disclosure. As shown in FIG. 7, in this embodiment, the robot 7 includes a processor 70, a memory 71, a computer program 72 stored in the memory 71 and executable on the processor 70, and a localization equipment 73. When executing (instructions in) the computer program 72, the processor 70 implements the steps in the above-mentioned embodiments of the patrol method using a robot, for example, steps S101-S103 shown in FIG. 1. Alternatively, when the processor 70 executes the (instructions in) computer program 72, the functions of each module/unit in the above-mentioned device embodiments, for example, the functions of the modules 601-603 shown in FIG. 6 are implemented. The robot 7 may further include a radar that can generate the working map of FIG. 5 by scanning.

Exemplarily, the computer program 72 may be divided into one or more modules/units, and the one or more modules/units are stored in the storage 71 and executed by the processor 70 to realize the present disclosure. The one or more modules/units may be a series of computer program instruction sections capable of performing a specific function, and the instruction sections are for describing the execution process of the computer program 72 in the robot 7.

It can be understood by those skilled in the art that FIG. 7 is merely an example of the robot 7 and does not constitute a limitation on the robot 7, and may include more or fewer components than those shown in the figure, or a combination of some components or different components. For example, the robot 7 may further include an input/output device, a network access device, a bus, and the like.

The processor 70 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 71 may be an internal storage unit of the robot 7, for example, a hard disk or a memory of the robot 7. The storage 71 may also be an external storage device of the robot 7, for example, a plug-in hard disk, a smart media card (SMC), a secure digital (SD) card, flash card, and the like, which is equipped on the robot 7. Furthermore, the storage 71 may further include both an internal storage unit and an external storage device, of the robot 7. The storage 71 is configured to store the computer program 72 and other programs and data required by the robot 7. The storage 71 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus/robot and method may be implemented in other manners. For example, the above-mentioned apparatus/robot embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented patrol method using a robot having a localization equipment, comprising executing on a processor of the robot steps of:
obtaining a preset patrol configuration file and reading a patrol sequence, a coordinate, and a navigation method of each patrol point from the patrol configuration file, wherein the patrol configuration file comprises at least two navigation methods;
obtaining a preset electronic map and obtaining a starting coordinate of the robot in the electronic map through the localization equipment; and
controlling the robot to move from the starting coordinate to the coordinate of each patrol point according to the patrol sequence by navigating the robot using the navigation method corresponding to the n-th patrol point in the patrol configuration file during moving the robot to the coordinate of the n-th patrol point, wherein 1≤n≤N, and N is an amount of the patrol point in the patrol configuration file.

2. The method of claim 1, wherein the navigation methods comprise a free navigation method and a local navigation method.

3. The method of claim 2, wherein if the navigation method corresponding to the n-th patrol point in the patrol configuration file is the free navigation method, the step of navigating the robot using the navigation method corresponding to the n-th patrol point in the patrol configuration file comprises:
performing a global path planning to obtain an optimal global path from the coordinate of the n−1-th patrol point to the coordinate of the n-th patrol point; and
controlling the robot to move according to the optimal global path, and performing an obstacle avoidance processing and a partial path planning during the movement to avoid obstacles on the optimal global path.

4. The method of claim 2, wherein if the navigation method corresponding to the n-th patrol point in the patrol configuration file is the local navigation method, the step of navigating the robot using the navigation method corresponding to the n-th patrol point in the patrol configuration file comprises:
reading a patrol direction of each patrol point from the patrol configuration file;
calculating a movement direction of the robot according to the coordinate of the n−1-th patrol point and the coordinate of the n-th patrol point;
calculating a first rotational angle based on the patrol direction of the n−1-th patrol point and the movement direction, and controlling the robot to rotate according to the first rotational angle such that an orientation of the robot is consistent with the movement direction;
controlling the robot to move from the coordinate of the n−1-th patrol point to the coordinate of the n-th patrol point according to the movement direction; and
calculating a second rotational angle according to the movement direction and the patrol direction of the n-th patrol point, and controlling the robot to rotate according to the second rotational angle such that an orientation of the robot is consistent with the patrol direction of the n-th patrol point.

5. The method of claim 1, wherein after the step of controlling the robot to move from the starting coordinate to the coordinate of each patrol point according to the patrol sequence further comprises:
reading patrol operation information of each patrol point from the patrol configuration file, and controlling the robot to perform a patrol operation corresponding to the patrol operation information at each patrol point.

6. A patrol apparatus for a robot having a localization equipment, comprising:
a configuration file obtaining module configured to obtain a preset patrol configuration file and read a patrol sequence, a coordinate, and a navigation method of each patrol point from the patrol configuration file, wherein the patrol configuration file comprises at least two navigation methods;
a coordinate determining module configured to obtain a preset electronic map and obtain a starting coordinate of the robot in the electronic map through the localization equipment; and
a motion patrol module configured to control the robot to move from the starting coordinate to the coordinate of each patrol point according to the patrol sequence by navigating the robot using the navigation method corresponding to the n-th patrol point in the patrol configuration file during moving the robot to the coordinate of the n-th patrol point, wherein 1≤n≤N, and N is an amount of the patrol point in the patrol configuration file.

7. The apparatus of claim 6, wherein the navigation methods comprise a free navigation method, if the navigation method corresponding to the n-th patrol point in the patrol configuration file is the free navigation method, the motion patrol module comprises:
a global path planning unit configured to perform a global path planning to obtain an optimal global path from the coordinate of the n−1-th patrol point to the coordinate of the n-th patrol point; and
an obstacle avoidance unit configured to control the robot to move according to the optimal global path, and performing an obstacle avoidance processing and a partial path planning during the movement to avoid obstacles on the optimal global path.

8. The apparatus of claim 6, wherein the navigation methods comprise a local navigation method, if the navigation method corresponding to the n-th patrol point in the patrol configuration file is the local navigation method, the motion patrol module comprises:
a patrol direction reading unit configured to read a patrol direction of each patrol point from the patrol configuration file;
a movement direction calculating unit configured to calculate a movement direction of the robot according to the coordinate of the n−1-th patrol point and the coordinate of the n-th patrol point;
a first rotation unit configured to calculating a first rotational angle based on the patrol direction of the n−1-th patrol point and the movement direction, and controlling the robot to rotate according to the first rotational angle such that an orientation of the robot coincides with the movement direction;
a movement control unit configured to control the robot to move from the coordinate of the n−1-th patrol point to the coordinate of the n-th patrol point according to the movement direction; and
a second rotation unit configured to calculate a second rotational angle according to the movement direction and the patrol direction of the n-th patrol point, and controlling the robot to rotate according to the second rotational angle such that an orientation of the robot coincides with the patrol direction of the n-th patrol point.

9. The apparatus of claim 6, wherein after the step of controlling the robot to move from the starting coordinate to the coordinate of each patrol point according to the patrol sequence further comprises:
a patrol operation module configured to read patrol operation information of each patrol point from the patrol configuration file, and control the robot to perform a patrol operation corresponding to the patrol operation information at each patrol point.

10. A robot, comprising:
a localization equipment;
a memory;
a processor; and
one or more computer programs stored in the memory and executable on the processor, wherein the one or more computer programs comprise:
instructions for obtaining a preset patrol configuration file and reading a patrol sequence, a coordinate, and a navigation method of each patrol point from the patrol configuration file, wherein the patrol configuration file comprises at least two navigation methods;
instructions for obtaining a preset electronic map and obtaining a starting coordinate of the robot in the electronic map through the localization equipment; and
instructions for controlling the robot to move from the starting coordinate to the coordinate of each patrol point according to the patrol sequence by navigating the robot using the navigation method corresponding to the n-th patrol point in the patrol configuration file during moving the robot to the coordinate of the n-th patrol point, wherein 1≤n≤N, and N is an amount of the patrol point in the patrol configuration file.

11. The robot of claim 10, wherein the navigation methods comprise a free navigation method and a local navigation method.

12. The robot of claim 11, wherein if the navigation method corresponding to the n-th patrol point in the patrol configuration file is the free navigation method, the instructions for navigating the robot using the navigation method corresponding to the n-th patrol point in the patrol configuration file comprise:
instructions for performing a global path planning to obtain an optimal global path from the coordinate of the n−1-th patrol point to the coordinate of the n-th patrol point; and
instructions for controlling the robot to move according to the optimal global path, and performing an obstacle avoidance processing and a partial path planning during the movement to avoid obstacles on the optimal global path.

13. The robot of claim 11, wherein if the navigation method corresponding to the n-th patrol point in the patrol configuration file is the local navigation method, the instructions for navigating the robot using the navigation method corresponding to the n-th patrol point in the patrol configuration file comprise:
instructions for reading a patrol direction of each patrol point from the patrol configuration file;
instructions for calculating a movement direction of the robot according to the coordinate of the n−1-th patrol point and the coordinate of the n-th patrol point;
instructions for calculating a first rotational angle based on the patrol direction of the n−1-th patrol point and the movement direction, and controlling the robot to rotate according to the first rotational angle such that an orientation of the robot is consistent with the movement direction;
instructions for controlling the robot to move from the coordinate of the n−1-th patrol point to the coordinate of the n-th patrol point according to the movement direction; and
instructions for calculating a second rotational angle according to the movement direction and the patrol direction of the n-th patrol point, and controlling the robot to rotate according to the second rotational angle such that an orientation of the robot is consistent with the patrol direction of the n-th patrol point.

14. The robot of claim 10, wherein the one or more computer programs further comprise:
instructions for reading patrol operation information of each patrol point from the patrol configuration file, and controlling the robot to perform a patrol operation corresponding to the patrol operation information at each patrol point.
